(19) United States
(12) Patent Application Publication
(10) Pub. No.: US 2016/0349540 A1
(43) Pub. Date: Dec. 1, 2016

(54) LIGHT MODULATION ELEMENT

(71) Applicant: DIC CORPORATION, Tokyo (JP)

(72) Inventors: Tomiki Ikeda, Tokyo (JP); Joji Kawamura, Kita-adachi-gun, Saitama (JP); Isa Nishiyama, Kita-adachi-gun, Saitama (JP); Yutaka Tachikawa, Sakura-shi (JP); Yoshinori Iwashita, Kita-adachi-gun, Saitama (JP)

(73) Assignee: DIC CORPORATION, Tokyo (JP)

(21) Appl. No.: 15/113,948

(22) PCT Filed: Feb. 12, 2015
(86) PCT No.: PCT/JP2015/053823

§ 371 Date: Jul. 25, 2016

(30) Foreign Application Priority Data
Feb. 14, 2014 (JP) 2014-026648

(51) Int. Cl. G02F 1/00; G02F 1/1343; G02F 1/137

(52) U.S. Cl. CPC G02F 1/0045; G02F 1/137; G02F 1/13439

(57) ABSTRACT

Provided is a light modulation element which is unlikely to cause photolysis or photodecomposition. Provided is a light modulation element formed of at least one or more transparent substrates and a dielectric layer stacked on at least one transparent substrate, in which the dielectric layer contains from 90 mol % to 100 mol % of an external field-reactive substance, and an energy level (T₁) of a lowest triplet excited state of the external field-reactive substance is from 2.6 eV to 5.4 eV. It is preferable that the external field-reactive substance contains from 35 mol % to 85 mol % of an external field-reactive substance (A-1) in which a value of S₁-T₁ is from 1.0 eV to 2.0 eV, when an energy level of an excited singlet of the external field-reactive substance (A) is set as (S₁).

### TECHNICAL FIELD

The present invention relates to a light modulation element.

### BACKGROUND ART

A light modulation element is expected to be used in fields such as optical recording technology, optical information processing technology, and display technology, as an element which spatially modulates and outputs a phase, intensity, an amplitude, and the like of input light in accordance with an input external signal, and is widely researched and developed. As a spatial light modulation element, for example, an element using an electric field response of liquid crystal has been known and broadly used as a display device (for example, see PTLs 1 to 2). With respect to the liquid crystals, the molecular alignment can be freely controlled by using a substrate surface treatment or an external field, and it is possible to freely change a phase or intensity of light using the characteristics described above.

### CITATION LIST

### Patent Literature

[PTL 1] JP-A-2008-143902

[PTL 2] JP-T-2009-504814

### SUMMARY OF INVENTION

### Technical Problem

The light modulation element is required to be stable against external factors such as light, heat, and the like. Particularly, since the light modulation element constantly modulates input light and outputs the modulated light, stability with respect to light is particularly important.

An object of the present invention is to provide a light modulation element which can respond to physical actions from the outside and is unlikely to cause photolysis or photodegradation.

### Solution to Problem

According to an aspect of the present invention, there is provided a light modulation element formed of at least one or more transparent substrates, and a dielectric layer stacked on at least one transparent substrate, in which the dielectric layer contains from 90 mol % to 100 mol % of an external field-reactive substance (A), and an energy level (T₁) of a lowest triplet excited state of the external field-reactive substance is from 2.6 eV to 5.4 eV.

In the present invention, it is preferable that the external field-reactive substance contains from 35 mol % to 85 mol % of an external field-reactive substance (A-1) in which a value of S₁-T₁ is from 1.0 eV to 2.0 eV, when an energy level of an excited singlet of the external field-reactive substance (A) is set as (S₁).

In the present invention, it is preferable that the external field-reactive substance contains 25 mol % to 65 mol % of an external field-reactive substance (A-1-1) in which the value of S₁-T₁ is 1,300 meV±200 meV.

In the present invention, it is preferable that a molar absorbance coefficient (s) of the external field-reactive substance (A) at a wavelength of 300 nm to 650 nm is less than 500, and it is preferable that a response is executed with a magnetic field, an electric field, an optical field, or a flow field as the external field.

In the light modulation element of the present invention, it is preferable that a transparent electrode is formed on at least one of the transparent substrates and the light modulation element modulates light in response to electromagnetic waves generated due to an electric signal input to the electrode.

### Advantageous Effects of Invention

According to the present invention, by including an external field-reactive substance having a predetermined energy level, it is possible to provide a light modulation element which is unlikely to cause photolysis and has high optical reliability.

### BRIEF DESCRIPTION OF DRAWINGS

FIG. 1 is a diagram showing optical stability of examples of the present invention.

### DESCRIPTION OF EMBODIMENTS

<Light Modulation Element>

There is provided a light modulation element of the present invention formed of at least one or more transparent substrates and a dielectric layer stacked on at least one transparent substrate, in which the dielectric layer contains an external field-reactive substance and the external field-reactive substance contains from 90 mol % to 100 mol % of an external field-reactive substance (A) in which an energy level (T₁) of a lowest triplet excited state of the external field-reactive substance is from 2.6 eV to 5.4 eV.

The light modulation element of the present invention realizes an optical function by modulating incident light and emitting modulated light. The light modulation element of the present invention can be used as a liquid crystal display element, a hologram element, a phase difference element such as a phase difference film, an optical communication element such as a wavelength division multiplexing element, a lighting element such as an electroluminescent element, and a 3D printer element.

Examples of a material of the transparent substrate used in the present invention include a flexible polymer such as polyethylene terephthalate (PET), polyethylene naphthalate (PEN), polyether sulfone (PES), polystyrene (PS), polyethylene (PE), polyarylate (PAR), polyether ether ketone (PEEK), polycarbonate (PC), polycycloolefin, polypropylene (PP), polyimide (PI), polyamide, polyimide amide, or triacetyl cellulose (TAC), a substrate prepared using a composite material such as a glass fiber reinforced plastic or cellulose fiber reinforced plastic, or inorganic materials such as glass. Among these, glass is preferable.

In the present invention, the light modulation element may include one or more transparent substrates and preferably includes two transparent substrates. In a case where two or more substrates are included, the substrates may be formed of the same type of material or may be formed of different materials.

In the present invention, a dielectric layer contains an external field-reactive substance.

In the present invention, the external field-reactive substance is a substance of which functions can be controlled in response to physical and chemical stimulations from an external field.

Examples of the external field of the external field-reactive substance include a magnetic field, an electric field, an optical field such as polarized light (a laser or a high-intensity lamp), and a fluctuation (a flow field) such as shear force.

In the present invention, examples of the external field-reactive substance include a dielectric substance such as a pyroelectric substance, a piezoelectric substance, a ferroelectric substance, a fluorescent substance, a phosphorescent substance, a dye, and a liquid crystal substance. The liquid crystal substance is mainly formed of an aggregate of liquid crystal molecules and the molecular alignment can be freely controlled by using an external field. For example, in a case where an electric field is used as the external field, an orientation of liquid crystal molecules aligned to be orthogonal to the substrate changes to be parallel to the substrate, or only a direction of liquid crystal molecules which are aligned substantially parallel to the substrate changes while maintaining the orientation to be parallel to the substrate, by adding a voltage between a plurality of electrodes, and therefore, it is possible to control a dynamic orientation of the liquid crystal molecules with an electric field. In addition, it is possible to apply a change to the order of liquid crystal phases by applying an action of increasing or decreasing a temperature to the liquid crystal substance as an external field. Further, it is possible to apply a change to the order of liquid crystal phases by applying light energy to the liquid crystal substance containing liquid crystal molecules and a dye or a phosphor substance by means of light irradiation as an external field. In any action, it is possible to modulate input light and extract as outgoing beams. As described above, the liquid crystal substance has a characteristic that it can cause light modulation with respect to various external fields. In the present invention, it is preferable that the external field-reactive substance is liquid crystal molecules.

In the present invention, as the external field-reactive substance, from 90 mol % to 100 mol % of the external field-reactive substance (A) in which an energy level (T₁) of a lowest triplet excited state of the external field-reactive substance is 2.6 eV to 5.4 eV is contained.

The light modulation element is an element which modulates light and is on the assumption that light is irradiated thereto. Accordingly, sufficient light stability is necessary so that properties do not change, even when light irradiation is continued for a long period of time.

As will be described later, the light modulation element of the present invention includes peripheral members such as a substrate, electrodes, wirings, an inorganic protective film, an organic protective film, a polarizing plate, or a phase difference film.

The light irradiation may cause degradation of the light modulation element, in some cases. This is because photolysis or photodegradation of constituent materials of the light modulation element occurs due to light irradiation energy. That is, in order to increase light stability of the light modulation element, first, it is considered to increase light stability of the external field-reactive substance constituting the light modulation element as a necessary condition.

Therefore, the inventors have paid attention to a deactivation process after optically exciting an external field-reactive substance or a peripheral member to generate an excited singlet, and generating a lowest triplet due to intersystem crossing of some parts thereof. This is because of a high probability of a photoreaction causing photolysis, since the excitation lifetime of the lowest triplet state is normally significantly longer than that of the excited singlet.

It is necessary that the substance absorbs light or movement of excitation energy occurs from excited molecules, so that an external field-reactive substance or a peripheral member can be photoexcited. Even when any one of an external field-reactive substance or a peripheral member is photoexcited by light irradiation, light stability of an element may be maintained, when they are independently deactivated without causing a photochemical reaction, to return the state thereof to a base state. This is a first mechanism for light stability.

Next, light stability of the light modulation element may be maintained, when after the light excitation of a substance, more suitable deactivation is performed through a relaxation process of energy by energy movement with respect to surrounding elements, such as energy movement between liquid crystal molecules, energy movement from liquid crystal molecules to a peripheral member, energy movement from a peripheral member to liquid crystal molecules, or energy movement between peripheral members, without causing excessive photolysis. This is a second mechanism for light stability.

The inventors have found that photolysis is prevented by deactivation through a suitable energy relaxation process and light stability can be maintained, in a case where the dielectric layer constituting the light modulation element contains from 90 mol % to 100 mol % of an external field-reactive substance having the energy level (T₁) of 2.6 eV to 5.4 eV.

The movement of excitation energy occurs from a material having a high energy level towards a material having a low energy level. Accordingly, a correlation between an energy level of an excited material and an energy level of a material receiving the energy is an important factor. Since the energy level (T₁) of the lowest triplet excited state of the external field-reactive substance is equal to or greater than 2.6 eV, it is considered that deactivation due to decomposition of the external field-reactive substance hardly occurs. This is because, it is considered that when the energy level is equal to or greater than 2.6 eV, the energy level of the external field-reactive substance is not excessively low and is a suitable value, and the excitation energy is suitably released also to a peripheral member having a lower energy level to perform gentle deactivation.

Meanwhile, when the energy level (T₁) of the lowest triplet excited state of the external field-reactive substance is less than 2.6 eV, since there are many compounds including an external field-reactive substance having poor light stability, deactivation accompanied with the decomposition of the compounds easily occurs. In addition, the energy level of the external field-reactive substance may be relatively lower than the energy level of the peripheral member, in many cases, and a possibility of deactivation through a relaxation process of releasing energy to the peripheral member may be decreased.

Since the energy level (T₁) of the lowest triplet excited state of the external field-reactive substance is equal to or smaller than 5.4 eV, the energy level of the external field-reactive substance is not excessively high and is a suitable value, and accordingly, a photoreaction accompanied with various photodegradations hardly occurs. In addition, the energy level of the peripheral member is in a relatively slightly lower level than the energy level of the external field-reactive substance, the suitable and gentle energy movement occurs therebetween, and deactivation can be performed through an energy relaxation step not accompanying excessive photoreaction. Therefore, it is possible to increase light stability of the light modulation element.

In a case where the energy level (T₁) of the lowest triplet excited state of the external field-reactive substance is higher than 5.4 eV, the energy level of the excited molecules is significantly high, and accordingly, the photoreaction of the external field-reactive substance itself may be easily induced, and this is one of the reasons for poor light stability. In addition, since the energy level of the peripheral member may be significantly lower than the energy level of the external field-reactive substance, in many cases, the energy movement from the peripheral member to the external field-reactive substance hardly occurs, whereas the energy movement from the external field-reactive substance to the peripheral member significantly easily occurs. Accordingly, the excited molecules of the external field-reactive substance may easily induce a chemical reaction accompanying decomposition of the peripheral member. This may be a second reason for poor light stability, with a high possibility.

The energy level (T₁) of the lowest triplet excited state of the external field-reactive substance (A) contained in the dielectric layer of the present embodiment is preferably from 3.0 eV to 4.9 eV and more preferably from 3.5 eV to 4.1 eV.

In the present invention, the energy level of the external field-reactive substance can be measured, for example, by emission spectrum measurement such as phosphorescence measurement. More specifically, the measurement is preferably performed based on a method disclosed in “Fluorometry: applications to biological science” Kazuhiko Kinosita and K. Mihashi, eds. Japan Scientific Societies press, Tokyo, 1983”.

The energy level is determined by a compound and the surrounding environment thereof, the energy level of the compound is measured by phosphorescence measurement, and furthermore, the energy level of the composition using the compound can be measured.

In addition, it is possible to set a composition having a desired energy level by suitably exchanging a compound having a high energy level and a compound having a low energy level by a person skilled in the art, but the excited molecules may show complicated behaviors such as energy movement and excimer formation, therefore, a resulted value is not simply linear and thus a certain technology and know-how are necessary in order to obtain a desired energy level in the composition.

The content of the external field-reactive substance (A) contained in the dielectric layer of the present embodiment is from 90 mol % to 100 mol % and is preferably from 93 mol % to 100 mol %.

In the present invention, by setting the content of the external field-reactive substance (A) to be in the range described above, it is possible to control a flow path of deactivation of the excited energy and improve light stability.

In the present invention, it is preferable that the external field-reactive substance contains from 35 mol % to 85 mol % of an external field-reactive substance (A-1) in which a value of S₁-T₁ is from 1.0 eV to 2.0 eV, when the energy level of the excited singlet of the external field-reactive substance (A) is set as (S).

The molecules in the lowest triplet state are important in a photochemical reaction from the view point of a length of the excitation lifetime, but, next, it is necessary to consider the excited singlet having the short excitation lifetime. The deactivation flow of the excitation energy regarding photodegradation is considered depending on the correlation of the energy levels between the external field-reactive substance and constituent elements of the light modulation element, in the same manner as the case of the lowest triplet. When a value of S₁-T₁ is from 1.0 eV to 2.0 eV, the energy level of the excited singlet is a suitable value, and accordingly, the energy can be suitably deactivated while being released between the peripheral members and the liquid crystal molecules.

Meanwhile, when the value of S₁-T₁ is less than 1.0 eV, light absorption easily occurs due to a low energy level of the excited singlet. When the excited singlet is generated due to the light absorption, a photochemical reaction caused by this occurs. There is a case where a photochemical reaction occurs directly from the excited singlet, and there is a case where the photochemical reaction is caused by the lowest triplet through the intersystem crossing.

When the value of S₁-T₁ is greater than 2.0 eV, excited molecules obtained by light absorption are hardly generated due to a high energy level of the excited singlet. In addition, in a case where the peripheral members absorb light and generate the excited singlet, energy movement from a peripheral member to an external field-reactive substance does not occur and a gentle relaxation step cannot be performed due to a high energy level. Accordingly, there is a high possibility that the peripheral member causes a photoreaction accompanying photolysis.

The value of S₁-T₁ of the external field-reactive substance (A-1) contained in the dielectric layer of the present embodiment is preferably from 1.2 eV to 1.9 eV and more preferably from 1.1 eV to 1.7 eV.

The content of the external field-reactive substance (A-1) contained in the dielectric layer of the present embodiment is preferably from 35 mol % to 85 mol % and preferably from 40 mol % to 80 mol %.

In the present invention, by setting the content of the external field-reactive substance (A-1) to be in the range described above, it is possible to improve light stability.

In the present invention, it is preferable that 25 mol % to 65 mol % of an external field-reactive substance (A-1-1) in which the value of S₁-T₁ is 1,300 meV±200 meV is contained. When the value of S₁-T₁ of the external field-reactive substance (A-1-1) is 1,300 meV±200 meV, the energy level thereof is a suitable value, and accordingly, the energy can be suitably deactivated while being released between the peripheral members and the liquid crystal molecules. In the present invention, by setting the content of the external field-reactive substance (A-1-1) to be in the range described above, it is possible to improve light stability.

In the present invention, a molar absorbance coefficient (∈) of the external field-reactive substance at a wavelength of 300 nm to 650 nm is preferably less than 500.

When the molar absorbance coefficient (∈) thereof at a wavelength of 300 nm to 650 nm is less than 500, it is possible to cause photodegradation to hardly occur.

In the present invention, examples of the external field of the external field-reactive substance include a magnetic field, an electric field, an optical field of polarized light (a laser or a high-intensity lamp), and a fluctuation (a flow field) of shear force. These are not required to come into contact with a surface of the substrate unlike a rubbing roller, an action can occur remotely, and accordingly, an orientation process can be easily performed even in a case of a large-scale liquid crystal display panel.

In a case where a magnetic field is used as the external field, an anisotropic axis of the liquid crystal molecules can be set to be in a magnetic field direction. Even in a case of using a polarized light as the external field, an anisotropic axis of the liquid crystal molecules can be set to be in a vibrating surface of the polarized light.

The light modulation element according to the present invention is a light modulation element including a dielectric layer interposed between two opposing transparent substrates, and it is preferable that a transparent electrode is formed on at least one of the transparent substrates and the light modulation element modulates light in response to electromagnetic waves generated due to an electric signal input to the electrodes.

As the two opposing transparent substrates used in the light modulation element, glass or a transparent material having flexibility such as plastic can be used.

The transparent substrate having a transparent electrode layer can be obtained by performing sputtering of indium tin oxide (ITO) on the transparent substrate such as a glass plate, for example.

In the transparent electrodes, transmittance is preferably high and electric resistance is preferably small. For example, a sheet resistance is preferably equal to or less than 150 ohm, preferably equal to or less than 100 ohm, and preferably equal to or less than 50 ohm.

When an example of a case where a liquid crystal substance is used as a dielectric phase is used, as a method of interposing the light modulation element having the dielectric layer between the two transparent substrates, a vacuum injection method or a one drop fill (ODF) method can be generally used. In the vacuum injection method, a dropping trace is not generated, but there is a problem that an injection trace remains. However, in the present invention, a display element manufactured by using the ODF method can be more suitably used. In a light modulation element manufacturing step using the ODF method, a liquid crystal display element can be manufactured by drawing an closed bank-like loop shape of an epoxy-based photocurable and sealing agent on any one of the substrates, a backplane or a front plane by using a dispenser, and dropping a predetermined amount of a liquid crystal composition therein under deaeration, and bonding the front plane and the backplane. The liquid crystal composition of the present invention can be preferably used, because the dropping of the liquid crystal composition in the ODF step can be stably performed.

The light modulation element according to the present invention has a structure in which a dielectric layer is interposed between two opposing substrates. The light modulation element according to the present invention may have the same structure as that of the liquid crystal display element obtained in the related art. That is, the orientation of the liquid crystal molecules may be controlled by an alignment film provided on the substrate and by applying electric power to the electrodes provided on the substrate. By providing a polarizing plate or a phase different film, the display can be performed by using this orientation state. The light modulation element can be applied to, TN, STN, VA, IPS, FFS, and ECB, but TN is particularly preferable.

### EXAMPLES

Hereinafter, the present invention will be described more specifically by using examples, but the present invention is not limited to the following examples.

The energy level (T₁) of the lowest triplet excited state and the energy level (S₁) of the excited singlet of the external field-reactive substance were measured and optical reliability with respect to the external field-reactive substances exhibiting the energy levels shown in the following tables were evaluated by using the following method, and the results of Examples 1 to 53 were determined as excellent. In the following tables, (A) represents the external field-reactive substance (A) in which the energy level (T₁) of the lowest triplet excited state is from 2.6 eV to 5.4 eV, (A-1) represents the external field-reactive substance (A-1) in which a value of S₁-T₁ of the external field-reactive substance is from 1.0 eV to 2.0 eV, when the energy level of the excited singlet of the external field-reactive substance (A) is set as (S₁), and (A-1-1) represents the external field-reactive substance (A-1-1) in which the value of S₁-T₁ of the external field-reactive substance is from 1,300 meV±200 meV, respectively.

[Evaluation Method of Light Reliability]

The measurement was performed based on a method disclosed in “Fluorometry: applications to biological science” Kazuhiko Kinosita and K. Mihashi, eds. Japan Scientific Societies press, Tokyo, 1983”.

In the following tables, the energy levels were measured based on a method disclosed in “Fluorometry: applications to biological science” Kazuhiko Kinosita and K. Mihashi, eds. Japan Scientific Societies press, Tokyo, 1983”.

TABLE 1

| | | | External | | | | |
|---|---|---|---|---|---|---|---|
| | No. of | | field-reactive | | | | |
| | light | No. of external | substance | | | | Light |
| | modulation | field-reactive | (A) | (A-1) | (A-1-1) | Energy | reliability |
| | element | substance | mol % | mol % | mol % | [eV] | (hour) |
| Example 1 | A | 1 | 100 | 100 | 42 | [3.66] | 1500 |
| Example 2 | B | 1 | 100 | 100 | 42 | [3.66] | 1450 |
| Example 3 | A | 2 | 95 | 71 | 57 | [3.85] | 7200 |
| Example 4 | B | 2 | 95 | 71 | 57 | [3.77] | 7200 |
| Example 5 | B | 3 | 100 | 48 | 33 | [4.95] | 5800 |
| Example 6 | B | 4 | 100 | 35 | 20 | [4.90] | 5900 |
| Example 7 | B | 5 | 100 | 92 | 52 | [3.78] | 1600 |
| Example 8 | B | 6 | 100 | 44 | 35 | [5.01] | 5000 |
| Example 9 | B | 7 | 100 | 45 | 19 | [3.89] | 6200 |
| Example | B | 8 | 100 | 42 | 25 | [5.09] | 5800 |
| 10 | | | | | | | |

TABLE 2

| | | | External | | | | |
|---|---|---|---|---|---|---|---|
| | No. of | | field-reactive | | | | |
| | light | No. of external | substance | | | | Light |
| | modulation | field-reactive | (A) | (A-1) | (A-1-1) | Energy | reliability |
| | element | substance | mol % | mol % | mol % | [eV] | (hour) |
| Example | A | 9 | 100 | 76 | 67 | [4.30] | 6000 |
| 11 | | | | | | | |
| Example | A | 10 | 100 | 55 | 41 | [4.98] | 8500 |
| 12 | | | | | | | |
| Example | A | 11 | 100 | 80 | 40 | [4.90] | 7800 |
| 13 | | | | | | | |
| Example | A | 12 | 100 | 49 | 44 | [3.81] | 6000 |
| 14 | | | | | | | |
| Example | A | 13 | 100 | 64 | 57 | [4.92] | 5900 |
| 15 | | | | | | | |
| Example | A | 14 | 100 | 78 | 70 | [4.85] | 8000 |
| 16 | | | | | | | |
| Example | A | 15 | 100 | 51 | 25 | [4.81] | 8600 |
| 17 | | | | | | | |
| Example | A | 16 | 100 | 52 | 34 | [4.84] | 8400 |
| 18 | | | | | | | |
| Example | A | 17 | 100 | 53 | 3 | [4.41] | 3800 |
| 19 | | | | | | | |
| Example | A | 18 | 100 | 51 | 17 | [3.75] | 6600 |
| 20 | | | | | | | |
| Example | A | 19 | 100 | 51 | 38 | [3.89] | 6700 |
| 21 | | | | | | | |

TABLE 3

| | | | External | | | | |
|---|---|---|---|---|---|---|---|
| | No. of | | field-reactive | | | | |
| | light | No. of external | substance | | | | Light |
| | modulation | field-reactive | (A) | (A-1) | (A-1-1) | Energy | reliability |
| | element | substance | mol % | mol % | mol % | [eV] | (hour) |
| Example | B | 20 | 100 | 61 | 10 | [3.99] | 7500 |
| 22 | | | | | | | |
| Example | B | 21 | 100 | 48 | 48 | [4.90] | 8000 |
| 23 | | | | | | | |
| Example | B | 22 | 100 | 36 | 36 | [4.85] | 8500 |
| 24 | | | | | | | |
| Example | B | 23 | 100 | 78 | 59 | [4.84] | 8500 |
| 25 | | | | | | | |
| Example | B | 24 | 100 | 50 | 19 | [3.66] | 2900 |
| 26 | | | | | | | |
| Example | B | 25 | 100 | 72 | 36 | [4.72] | 8000 |
| 27 | | | | | | | |
| Example | B | 26 | 100 | 51 | 49 | [4.83] | 9000 |
| 28 | | | | | | | |
| Example | B | 27 | 100 | 58 | 27 | [3.85] | 7600 |
| 29 | | | | | | | |
| Example | B | 28 | 100 | 52 | 27 | [3.76] | 6500 |
| 30 | | | | | | | |
| Example | B | 29 | 100 | 56 | 31 | [3.90] | 6500 |
| 31 | | | | | | | |
| Example | B | 30 | 100 | 72 | 62 | [4.79] | 7600 |
| 32 | | | | | | | |
| Example | B | 31 | 100 | 52 | 26 | [3.80] | 7500 |
| 33 | | | | | | | |

TABLE 4

| | | | External | | | | |
|---|---|---|---|---|---|---|---|
| | No. of | | field-reactive | | | | |
| | light | No. of external | substance | | | | Light |
| | modulation | field-reactive | (A) | (A-1) | (A-1-1) | Energy | reliability |
| | element | substance | mol % | mol % | mol % | [eV] | (hour) |
| Example | C | 32 | 100 | 80 | 53 | [3.70] | 6800 |
| 34 | | | | | | | |
| Example | C | 33 | 100 | 51 | 40 | [3.86] | 7900 |
| 35 | | | | | | | |
| Example | C | 34 | 100 | 55 | 0.3 | [3.74] | 7800 |
| 36 | | | | | | | |
| Example | C | 35 | 95 | 67 | 36 | [3.88] | 6900 |
| 37 | | | | | | | |
| Example | C | 36 | 100 | 47 | 36 | [4.89] | 8500 |
| 38 | | | | | | | |
| Example | C | 37 | 100 | 59 | 59 | [5.00] | 5500 |
| 39 | | | | | | | |
| Example | C | 38 | 100 | 68 | 65 | [5.09] | 5900 |
| 40 | | | | | | | |
| Example | C | 39 | 100 | 54 | 38 | [3.73] | 6900 |
| 41 | | | | | | | |
| Example | C | 40 | 100 | 53 | 53 | [4.94] | 5400 |
| 42 | | | | | | | |
| Example | C | 41 | 100 | 39 | 28 | [3.77] | 6800 |
| 43 | | | | | | | |
| Example | C | 42 | 100 | 40 | 38 | [3.83] | 7400 |
| 44 | | | | | | | |

TABLE 5

| | | | External | | | | |
|---|---|---|---|---|---|---|---|
| | No. of | | field-reactive | | | | |
| | light | No. of external | substance | | | | Light |
| | modulation | field-reactive | (A) | (A-1) | (A-1-1) | Energy | reliability |
| | element | substance | mol % | mol % | mol % | [eV] | (hour) |
| Example | D | 43 | 100 | 40 | 38 | [4.78] | 8500 |
| 45 | | | | | | | |
| Example | D | 44 | 100 | 65 | 59 | [4.86] | 9000 |
| 46 | | | | | | | |
| Example | D | 45 | 100 | 50 | 27 | [5.05] | 5800 |
| 47 | | | | | | | |
| Example | D | 46 | 93 | 51 | 38 | [3.90] | 6000 |
| 48 | | | | | | | |
| Example | D | 47 | 100 | 46 | 39 | [3.81] | 7000 |
| 49 | | | | | | | |
| Example | D | 48 | 100 | 44 | 36 | [4.95] | 4500 |
| 50 | | | | | | | |
| Example | D | 49 | 100 | 40 | 15 | [4.60] | 3000 |
| 51 | | | | | | | |
| Example | D | 50 | 100 | 30 | 11 | [3.55] | 1900 |
| 52 | | | | | | | |
| Example | D | 51 | 100 | 65 | 48 | [3.88] | 7500 |
| 53 | | | | | | | |

TABLE 6

| | | | External | | | | |
|---|---|---|---|---|---|---|---|
| | No. of | | field-reactive | | | | |
| | light | No. of external | substance | | | | Light |
| | modulation | field-reactive | (A) | (A-1) | (A-1-1) | Energy | reliability |
| | element | substance | mol % | mol % | mol % | [eV] | (hour) |
| Comparative | A | 101 | 81 | 81 | 71 | [2.20] | 520 |
| Example 1 | | | | | | | |
| Comparative | B | 102 | 78 | 70 | 70 | [2.15] | 800 |
| Example 2 | | | | | | | |
| Comparative | C | 103 | 52 | 42 | 11 | [5.75] | 720 |
| Example 3 | | | | | | | |

### Example 54

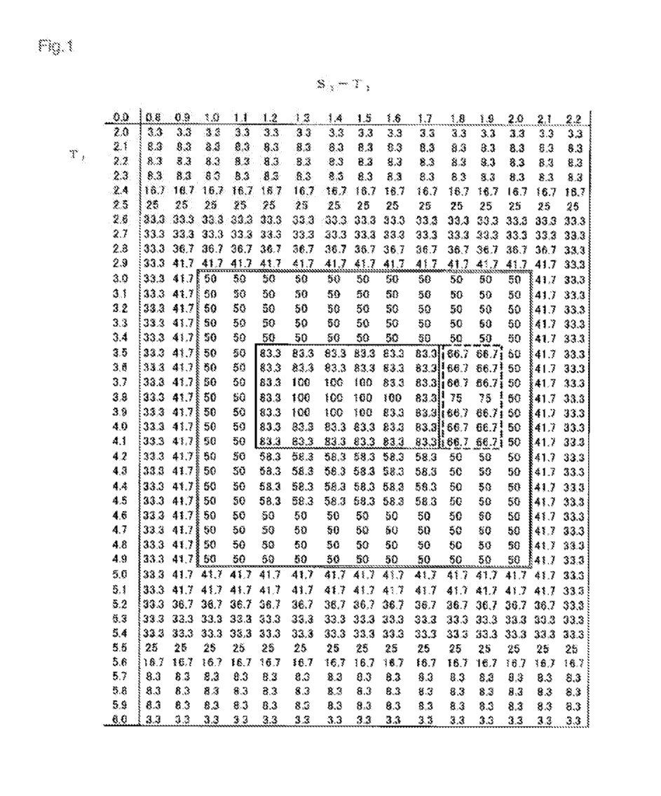

The energy level of the excited triplet of the liquid crystal composition was set as (T₁), and the energy level of the excited singlet was set as (S₁), and the liquid crystal compounds were mixed with each other such that T₁ of the liquid crystal composition was from 2.0 eV to 5.4 eV and a value of T₁-S₁ was from 1.0 eV to 2.0 eV, and a liquid crystal composition was prepared. The values of T₁ and T₁-S₁ of each liquid crystal composition are shown in FIG. 1. In the present example, 615 liquid crystal compositions in which the values of T₁ (vertical axis of FIG. 1, from 2.0 to 6.0) and T₁-S₁ (horizontal axis of FIG. 1, from 0.8 to 2.2) were set as the values shown in FIG. 1 were prepared.

The evaluation of light stability was performed with respect to all of the liquid crystal compositions. The results thereof are shown in FIG. 1.

FIG. 1 illustrates results obtained by setting most excellent light stability as “100” and digitizing light stability by using relative evaluation.

As shown in FIG. 1, the liquid crystal compositions having T₁ of 2.6 eV to 5.4 eV have the result value equal to or greater than 33.3 and light stability was excellent. In contrast, the liquid crystal compositions having T₁ less than 2.6 or greater than 5.4, have the result value equal to or smaller than 25 and light stability was not excellent.

Moreover, when T₁ was from 3.0 eV to 4.9 eV, light stability was excellent, and when T₁ was from 3.5 eV to 4.1 eV, light stability was particularly excellent.

In addition, the liquid crystal compositions having T₁-S₁ of 1.0 eV to 2.0 eV (within double line in FIG. 1) have the result value equal to or greater than 50, and light stability was further excellent, and among these, the liquid crystal compositions having T₁-S₁ of 1.2 eV to 1.9 eV have particularly excellent light stability.

1. A light modulation element formed of at least one or more transparent substrates and a dielectric layer stacked on at least one transparent substrate,
wherein the dielectric layer contains from 90 mol % to 100 mol % of an external field-reactive substance (A), and an energy level (T₁) of a lowest triplet excited state of the external field-reactive substance is from 2.6 eV to 5.4 eV.

2. The light modulation element according to claim 1,
wherein the external field-reactive substance contains from 35 mol % to 85 mol % of an external field-reactive substance (A-1) in which a value of S₁-T₁ is from 1.0 eV to 2.0 eV when an energy level of an excited singlet of the external field-reactive substance (A) is set as (S₁).

3. The light modulation element according to claim 2,
wherein the external field-reactive substance contains 25 mol % to 65 mol % of an external field-reactive substance (A-1-1) in which the value of S₁-T₁ is from 1,300 meV±200 meV.

4. The light modulation element according to claim 1,
wherein a molar absorbance coefficient (E) of the external field-reactive substance (A) at a wavelength of 300 nm to 650 nm is less than 500.

5. The light modulation element according to claim 1,
wherein a response is executed with a magnetic field, an electric field, an optical field, or a flow field as the external field.

6. The light modulation element according to claim 1, comprising a dielectric layer interposed between two opposing transparent substrates,
wherein a transparent electrode is formed on at least one of the transparent substrates, and
wherein the light modulation element modulates light in response to electromagnetic waves generated due to an electric signal input to the electrode.
